(19) United States
(12) Patent Application Publication
(10) Pub. No.: US 2011/0061376 A1
(43) Pub. Date: Mar. 17, 2011

(54) ENERGY CONVERSION ASSEMBLIES AND ASSOCIATED METHODS OF USE AND MANUFACTURE

(75) Inventor: Roy E. McAlister, Phoenix, AZ (US)

(73) Assignee: McAlister Technologies, LLC, Phoenix, AZ (US)

(21) Appl. No.: 12/857,433

(22) Filed: Aug. 16, 2010

Related U.S. Application Data
(63) Continuation-in-part of application No. 12/707,651, filed on Feb. 17, 2010.
Application No. 12/707,651 is a continuation-in-part of application No. PCT/US10/24497, filed on Feb. 17, 2010.
Application No. PCT/US10/24497 is a continuation-in-part of application No. 12/707,653, filed on Feb. 17, 2010.
Application No. 12/707,653 is a continuation-in-part of application No. 12/707,656, filed on Feb. 17, 2010.
Application No. 12/707,656 is a continuation-in-part of application No. PCT/US10/24499, filed on Feb. 17, 2010.
Application No. PCT/US10/24499 is a continuation-in-part of application No. PCT/US10/24498, filed on Feb. 17, 2010.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.
(60) Provisional application No. 61/153,253, filed on Feb. 17, 2009.
(60) Provisional application No. 61/237,476, filed on Aug. 27, 2009.
(60) Provisional application No. 61/304,403, filed on Feb. 13, 2010.

(30) Foreign Application Priority Data
Feb. 17, 2010 (US) PCT/US10/24497
Feb. 17, 2010 (US) PCT/US10/24498
Feb. 17, 2010 (US) PCT/US10/24499

(51) Int. Cl. F03B 13/18; F17D 1/16

(52) U.S. Cl. 60/498; 60/497; 137/13

(57) ABSTRACT

Embodiments of the disclosure are directed to conversion of renewable energy such as solar, wind, falling water, wave and biomass resources into energy forms for practical transport by existing electricity and natural gas transport systems and includes embodiments for cyclic conversion of rectilinear forces into electricity wherein charged particles force a separate population of charged particles to flow in a separate circuit to create an electric current. Forces exerted at a first frequency are converted into cyclic electrical current at a frequency that is a multiple of the frequency of the forces. Similar arrangements are provided for conversion of rotary forces into electricity. Components of the disclosure can be manufactured at a high rate from very low cost materials with minimum energy requirements for the purpose of generation of low-cost electricity from linear motion engines and renewable forces such as ocean waves and flowing fluids such as water or air. Corrosion and biofouling are eliminated by application of cathodic and chemical treatments produced by the operation of the disclosure. Various embodiments of the disclosure allow improved cogeneration and motor vehicles, household appliances, and industrial equipment to be operated on energy converted from rectilinear forces.

### CROSS-REFERENCE TO RELATED APPLICATION(S)

The present application claims priority to and the benefit of U.S. Provisional Application No. 61/304,403, filed Feb. 13, 2010 and titled FULL SPECTRUM ENERGY AND RESOURCE INDEPENDENCE. The present application is a continuation-in-part of each of the following applications: U.S. patent application Ser. No. 12/707,651, filed Feb. 17, 2010 and titled ELECTROLYTIC CELL AND METHOD OF USE THEREOF; PCT Application No. PCT/US10/24497, filed Feb. 17, 2010 and titled ELECTROLYTIC CELL AND METHOD OF USE THEREOF; U.S. patent application Ser. No. 12/707,653, filed Feb. 17, 2010 and titled APPARATUS AND METHOD FOR CONTROLLING NUCLEATION DURING ELECTROLYSIS; PCT Application No. PCT/US10/24498, filed Feb. 17, 2010 and titled APPARATUS AND METHOD FOR CONTROLLING NUCLEATION DURING ELECTROLYSIS; U.S. patent application Ser. No. 12/707,656, filed Feb. 17, 2010 and titled APPARATUS AND METHOD FOR GAS CAPTURE DURING ELECTROLYSIS; and PCT Application No. PCT/US10/24499, filed Feb. 17, 2010 and titled APPARATUS AND METHOD FOR CONTROLLING NUCLEATION DURING ELECTROLYSIS; each of which claims priority to and the benefit of the following applications: U.S. Provisional Patent Application No. 61/153,253, filed Feb. 17, 2009 and titled FULL SPECTRUM ENERGY; U.S. Provisional Patent Application No. 61/237,476, filed Aug. 27, 2009 and titled ELECTROLYZER AND ENERGY INDEPENDENCE TECHNOLOGIES; U.S. Provisional Application No. 61/304,403, filed Feb. 13, 2010 and titled FULL SPECTRUM ENERGY AND RESOURCE INDEPENDENCE. Each of these applications is incorporated by reference in its entirety.

### TECHNICAL FIELD

This disclosure relates to improved conversion of renewable forces that produce cyclic rectilinear or rotary motion into electricity and/or hydrogen; distribution of electricity and/or hydrogen substantially by existing electrical and pipeline networks; dense storage of fuel fluids such as hydrogen and methane for transportation and cogeneration applications; improved production of electricity by rotary and/or rectilinear generation techniques; and production and/or recovery of potable heated water for homemaking and commercial purposes of air conditioning, washing, and cooking.

### BACKGROUND

The Industrial Revolution has been fueled with petrocarbons such as coal, oil and natural gas. From the time of earliest records to the middle 1600's, human population grew at a very slow rate. Since about 1700, startling increases in human population have closely followed the Industrial Revolution's exploitation of petrocarbons, metallic ores, water, and air. The fossil equivalent of some 180 million barrels of oil are burned each day to support various human pursuits of the good life. At the beginning of the 21st century, the human population on earth will exceed six billion persons which doubles the 1960 population.

For millions of years, fossil deposits provided safe and natural storage of carbon and radioactive elements. Burning these fossil deposits releases dangerous substances into the environment. Global combustion of 2,800 million tons of coal each year releases about 10,200 million tons of carbon dioxide, 8,960 tons of thorium and 3,640 tons of uranium to the air, water, and food chain.

Burning the fossil equivalent of 180 million barrels of oil per day has polluted the global atmosphere with carbon dioxide and other objectionable emissions. The present concentration of carbon dioxide in the atmosphere is about 25 to 30% greater than at any time in the last 160,000 years. This increased presence of carbon dioxide traps solar energy in the atmosphere. Because more energy is trapped in the atmosphere, there is more evaporation of the oceans. This results in more extreme weather-related events such as floods, hurricanes, and tornados. Combustion of fossil fuels for generation of electricity exceeds all other sources of carbon-dioxide pollution.

The market for electricity exceeds seven hundred billion dollars annually and is expected to reach one trillion dollars early in the 21st century. Generation of sufficient electricity to meet present requirements along with growing transportation needs for hydrogen and electric vehicles must utilize renewable resources in order to prevent catastrophic degradation of the environment by emissions from fossil-fuel combustion.

Cogeneration using an opposed-piston stratified-charge engine with a linear generator between the pistons is needed to greatly simplify the apparatus needed for more than doubling energy conversion efficiency compared to central power plant production of electricity. Similarly a linear generator attached to a harmonic Stirling, Schmidt, or Ericsson cycle engine would greatly simplify cogeneration. But an improved linear generator is needed to overcome the 5% to 20% loss of efficiency that known linear generators impose compared to rotary generators.

Ocean waves represent a vast but untapped source of dependable energy. Waves are developed by winds that impart cyclic elevations to the surface of the ocean. Solar energy powers the winds and thus the waves that are common to all oceans and other open surfaces of water. Earth's oceans provide wave power of 10 to 80 kilowatts per meter of wave height. Most of the populated areas of the continents are relatively near coastal areas with ocean waves that average at least one meter in height.

Numerous attempts to harness wind, falling water, tides, and ocean waves have been made and include a variety of machines designed to be powered by waves for the purpose of making electricity. The prior art includes Hydropiezoelectric Devices; Mechanical Rockers such as the Salter Duck; Linear Generators driven by floats and hinges; Water Column Air Turbine Generators; and the Gulf Stream Water Wheel. U.S. Pat. Nos. 4,843,249; 4,034,231; 4,048,512; 4,137,005; 4,357,543; 4,625,124; and 5,443,361 illustrate additional difficulties and complications involved with approaches of the prior art. Common problems that such systems present include:

1. Expensive materials. The expense of the materials needed and manufacturing requirements generally far exceeds the cost of equal capacity wind machines that could be located on more protected land sites.

2. Corrosion of components. Virtually all of the materials that have been developed for land applications provide disappointing performance in ocean atmospheres. Steel rusts and spalls; aluminum and magnesium alloys develop intergranular corrosion; titanium and stainless alloys are tarnished and fail in oxidation-reduction cells that are generated by ocean atmospheres; steel reinforced concrete swells and spalls.

3. Bio-fouling. Marine life forms such as barnacles and algae grow on ocean structures and have presented difficult if not impossible impedances to machine operation.

4. Storm damage. Even if machines are temporarily able to withstand deterioration due to corrosion and bio-fouling, ocean storms present violent wind and wave forces that far exceed average conditions and often damage or blow away equipment.

Another aspect of the problem with such prior art efforts has been the characteristic of requiring complicated and expensive components which waste energy from smaller and larger waves. To overcome this, other prior art systems employ sophisticated highly tuned systems that are adapted to specific wave conditions. Corollaries of these problems are unacceptable down times, extensive maintenance requirements, high operating expenses, and unacceptable rate of return on investment.

Common difficulties with past approaches involve the intermittent nature of renewable energy sources. A related problem is the great cost and difficulty of storing surplus electricity from existing and renewable electricity generation systems. Past approaches using chemical batteries, flywheels, capacitors, and inductors fail to provide cost-effective storage of surplus energy for future usage.

### SUMMARY

An object of the present disclosure is to overcome the problems noted above. In accordance with the principles of the present disclosure, this objective is accomplished by providing a process for manufacturing an efficient, low-maintenance, linear generator from very low cost materials.

An object of the disclosure is to improve existing natural gas storage and distribution systems by incorporation of occasional addition of hydrogen produced from surplus electricity and/or other forms of surplus energy and placement of selective separation systems for removal of hydrogen from other ingredients typically conveyed by such natural gas systems. Another object of the present disclosure is to provide a system that utilizes charged particles to force charged particles in a separate circuit to flow and accomplish useful work.

An object of the present disclosure is to convert forces exerted at a first frequency to electrical energy with current at a frequency that is a multiple of the frequency of the forces.

Another object of the present disclosure is to manufacture the components of the disclosure at a high rate from very low cost materials with minimum energy requirements.

Another object of the present disclosure is to provide wave generators that overcome corrosion and biofouling in ocean and lake atmospheres.

Another object of the present disclosure is to provide a system that is adaptive to application circumstances such as wave conditions or engine operation for the purpose of producing electricity at a high efficiency.

An object of the present disclosure is to provide a system that utilizes ingredients that are derived from the surroundings such as ozone from water and chlorine from salt water in which such ingredients are utilized to control biofouling.

Another object of the present disclosure is to provide a system that utilizes gases such as hydrogen that are derived from the atmosphere in which the invention is applied to control the buoyancy of components of the invention.

Another object of the present disclosure is to distribute hydrogen in existing underground natural gas conduits and to selectively filter hydrogen from mixtures at desired locations.

Another object of the present disclosure is to distribute electricity on existing electricity distribution grids from given producers to contract buyers at desired locations.

Another object of the present disclosure is to store hydrogen and methane at elevated pressure for purposes of recovering stored pressure energy along with stored chemical energy.

Another object of the present disclosure is to provide for rapid startup and generation of electricity using pressure and chemical storage of hydrogen and methane.

Another object of the disclosure is to provide a system for achieving a sustainable economy in which energy users are provided with convenient, safe, and cost-effective ways to improve the efficiency of mining, farming, home-making, manufacturing, and transportation operations.

An object of the disclosure is to provide improved methods and apparatus for cogeneration purposes.

An object of the disclosure is to provide improved methods and apparatus for agricultural industries.

An object of the disclosure is to provide improved methods and apparatus for production of chemicals and polymers.

An object of the disclosure is to provide improved methods and apparatus for production of clean energy in transportation and electricity generation applications.

These and other objects of the present disclosure will become more apparent during the course of the following detailed description and appended claims.

The disclosure may be best understood with reference to the accompanying drawings, wherein an illustrative embodiment is shown.

This energy conversion regime provides a synergistic system for making the best utilization and payback from the existing large investment that Civilization has made in electricity grids and pipeline networks by harnessing various renewable energy sources such as wave, wind, hydro, and tidal energy. In application, this regime will enable the Industrial Revolution to be evolved from a non-sustainable revolution into a sustainable economic reformation that facilitates realization of the principle of wealth addition. This regime of energy conversion options provides opportunities to achieve wealth expansion in the farming, manufacturing, commerce, transportation, and home making activities of Civilization by providing energy intensive goods from renewable energy sources.

While certain exemplary embodiments have been described and/or shown in the accompanying drawings, it is understood that such embodiments are merely illustrative of and not restrictive on the broad disclosure in embodiments including: electric lighting, microwave cooking, microwave communications, electric motor drives, induction heating, electromagnet drives, electrodialysis, electro-separation of metals from ores, electro-separation of hydrogen from water, and electric-arc devices, and that this disclosure is not limited to the specific constructions and arrangements shown and described, since various other modifications should occur to those skilled in the art.

### BRIEF DESCRIPTION OF THE DRAWINGS

FIG. 1 is a cross-sectional side view of a linear generator assembly configured in accordance with an embodiment of the disclosure for converting wave energy into electricity.

FIG. 2 is a schematic diagram of components of the linear generator assembly of FIG. 1 configured in accordance with embodiments of the disclosure.

FIG. 3 is a schematic diagram of additional components of the linear generator assembly of FIG. 1 configured in accordance with further embodiments of the disclosure.

FIG. 4 is a cross-sectional side view of a rotary generator assembly configured in accordance with an embodiment of the disclosure for converting energy in moving water into electricity.

FIG. 5 is a schematic diagram of components of the rotary generator assembly of FIG. 4 configured in accordance with embodiments of the disclosure.

FIG. 6 is a schematic end view of the rotary generator assembly of FIG. 4.

FIG. 7 is a schematic side view of a rotary generator assembly configured in accordance with another embodiment of the disclosure.

8 is a schematic cross-sectional view taken substantially along lines 8-8 of FIG. 7.

FIG. 9 is a schematic illustration of an embodiment of the disclosure for converting a renewable energy source, such as water energy into electrical energy, electrical energy into chemical energy, and convenient delivery of hydrogen and or oxygen to a vehicle and other energy applications.

FIG. 10 is a schematic view of a generator assembly configured in accordance with a further embodiment of the disclosure.

FIG. 11 is a cross-sectional side partial view of a filter assembly configured in accordance with an embodiment of the disclosure.

FIG. 12 is an enlarged view of a portion of the apparatus shown in FIG. 11.

FIG. 13 is a schematic diagram of a selective outcome filter assembly configured in accordance with another embodiment of the disclosure.

FIG. 14 is a process flow diagram of a method configured in accordance with an embodiment of the disclosure.

### DETAILED DESCRIPTION

The present application incorporates by reference in its entirety the subject matter of U.S. Provisional Patent Application No. 60/626,021, filed Nov. 9, 2004 and titled MULTIFUEL STORAGE, METERING AND IGNITION SYSTEM (Attorney Docket No. 69545-8013US). The present application incorporates by reference in their entirety the subject matter of each of the following U.S. patent applications, filed concurrently herewith on Aug. 16, 2010 and titled: METHODS AND APPARATUSES FOR DETECTION OF PROPERTIES OF FLUID CONVEYANCE SYSTEMS (Attorney Docket No. 69545-8003US); COMPREHENSIVE COST MODELING OF AUTOGENOUS SYSTEMS AND PROCESSES FOR THE PRODUCTION OF ENERGY, MATERIAL RESOURCES AND NUTRIENT REGIMES (Attorney Docket No. 69545-8025US); ELECTROLYTIC CELL AND METHOD OF USE THEREOF (Attorney Docket No. 69545-8026US); SUSTAINABLE ECONOMIC DEVELOPMENT THROUGH INTEGRATED PRODUCTION OF RENEWABLE ENERGY, MATERIALS RESOURCES, AND NUTRIENT REGIMES (Attorney Docket No. 69545-8040US); SYSTEMS AND METHODS FOR SUSTAINABLE ECONOMIC DEVELOPMENT THROUGH INTEGRATED FULL SPECTRUM PRODUCTION OF RENEWABLE ENERGY (Attorney Docket No. 69545-8041US); SUSTAINABLE ECONOMIC DEVELOPMENT THROUGH INTEGRATED FULL SPECTRUM PRODUCTION OF RENEWABLE MATERIAL RESOURCES (Attorney Docket No. 69545-8042US); METHOD AND SYSTEM FOR INCREASING THE EFFICIENCY OF SUPPLEMENTED OCEAN THERMAL ENERGY CONVERSION (SOTEC) (Attorney Docket No. 69545-8044US); GAS HYDRATE CONVERSION SYSTEM FOR HARVESTING HYDROCARBON HYDRATE DEPOSITS (Attorney Docket No. 69545-8045US); APPARATUSES AND METHODS FOR STORING AND/OR FILTERING A SUBSTANCE (Attorney Docket No. 69545-8046US); ENERGY SYSTEM FOR DWELLING SUPPORT (Attorney Docket No. 69545-8047US); and INTERNALLY REINFORCED STRUCTURAL COMPOSITES AND ASSOCIATED METHODS OF MANUFACTURING (69545-8049US).

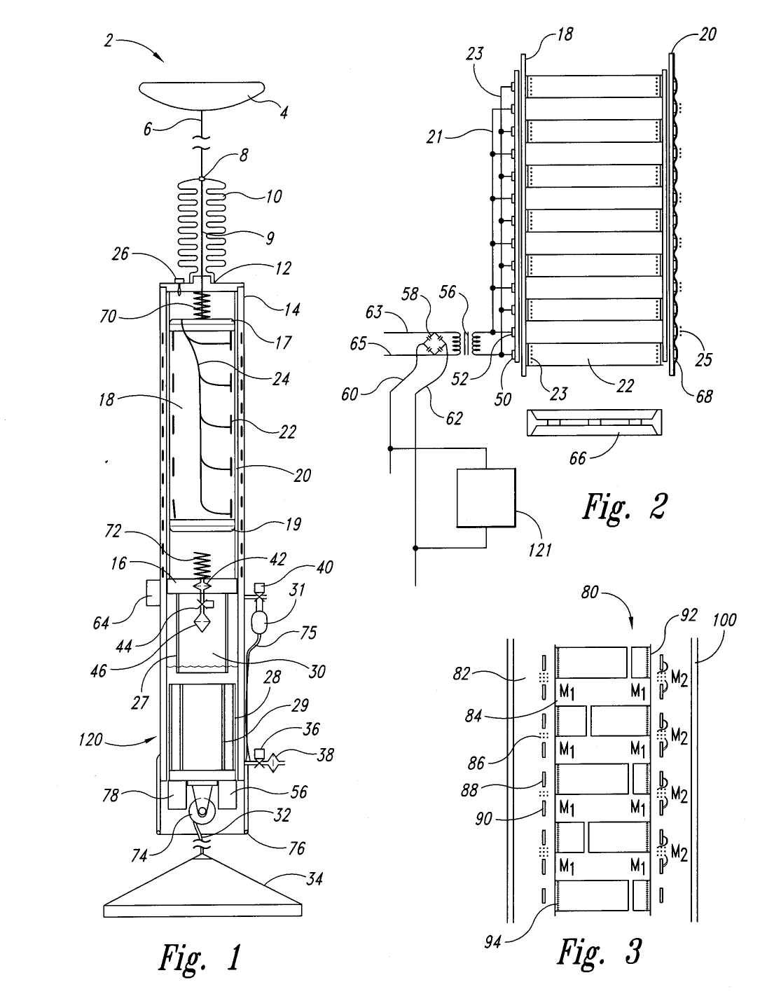

FIG. 1 is a cross-sectional side view of an energy conversion system or generator assembly 2 configured in accordance with an embodiment of the disclosure for converting wave energy, or other forms of water energy or movement in water, into electricity. FIG. 2 is a schematic diagram of components of the linear generator assembly of FIG. 1 configured in accordance with embodiments of the disclosure. Referring to FIGS. 1 and 2 together, in certain embodiments wave energy is used to supply the cyclic rectilinear force required to drive linear generator assembly 2. As shown in the embodiment illustrated in FIG. 1, a motion driver or flotation unit 4 moves up and down as it rides waves and supplies a lifting force on attached cable 6 which is sealed by fitting 8 to bellows 10 which is preferably made of EPDM rubber. The lower portion of bellows 10 is sealed to a bulkhead 12 which is also sealed to a housing or outer tube 14. The housing or outer tube 14 at least partially defines a cavity therein. At the middle section of outer tube 14, a bulkhead assembly 16 is sealed to the outer tube 14. This provides a hermetic seal of the contents of outer tube 14 but allows for relative reciprocating motion between the contents of the outer tube 14. For example, a first generator assembly or stationary tube 20 can remain generally stationary relative to the outer tube 14, and a second generator assembly or generator tube 18 can move relative to the first stationary tube 20. As explained in detail below, the stationary tube 20 and the generator tube 18 each includes multiple spaced apart conductors or metallic rings to generator electricity as the generator tube 18 moves relative to the stationary tube 20.

In the illustrated embodiment, a rod 9 couples the generator tube 18 to the cable 6. In certain embodiments, the rod 9 can be a polished rod 9 made from a low-cost stainless alloy such as type 410 SS. Moreover, the generator tube assembly 18 moves up and down (with respect to stationery tube 20) and can be made of a suitable material such as polypropylene, linear low-density polyethylene, or very low-density polyethylene by extrusion or rotational molding techniques in the tubular shape shown in FIGS. 1 and 2. On the inside of tube 18 are assembled spaced metallic bands 22 of a suitable metal such as copper, silver, or aluminum. These bands are connected to charging lead 24 which is used to impart a charge such as a high voltage accumulation of electrons on bands 22 by connecting 24 to a suitable high voltage source at 26 while engaged through the socket shown to charging lead 24.

As shown in FIG. 2, the schematic circuit diagrams of a transformer 56, a full-wave rectifier bridge 58, and an inverter 121 are provided to teach the principles of operation of certain features of the assembly 2. Persons of ordinary skill in the art of energy conversion will understand that these components can be protected from environmental degradation, and if needed provided within water-tight enclosures in actual operation. Moreover, charging lead 24 may be occasionally connected through contactor 26 to a suitable source such as transformer 56 or rectifier assembly 58 for replenishing zones 22 with additional electrons as needed to restore gradual loss of charge. Negative charge conditions 23 and 25 are shown in FIG. 2. Embodiments of the disclosure can be practiced by operating on a repulsive-force basis with a surplus of negative or positive charges, or by operating on an attractive-force basis by charging rings such as 23 and 25 with oppositely charged particles. In certain embodiments, it may be advantageous to operate zones 50, the primary winding of 56, along with zones 52 with the same charge that zones 22 receive and to also replenish this charge periodically by connection to the output of transformer 56 or rectifier assembly 58 for purposes of maintaining a high current magnitude in the primary of 56.

Depending upon the size of the embodiment needed, it may be preferred to bond an interference-fit cylindrical tube or dielectric spacers 66 within each ring 22 for the purpose of maintaining dimensional stability in operation. In smaller applications where waves up to 1 meter in height are available it may be preferred to use reinforcements 66. In waters where waves greater than about 1 meter are available, it may be preferred to reinforce generator tube 18 with a structural tube which is not shown but which serves as an elongated form of dielectric spacers 66 with sufficient wall thickness to provide the desired reinforcement and dimensional stability in all modes of operation. Similarly, in certain embodiments it is preferred to reinforce each ring 50 and 52 with a high-strength, oriented carbon, glass, or polyolefin tape 68 for purposes of maintaining dimensional stability. In operation of smaller embodiments, stationary tube 20 may be rigidized by internal pressure which preferably approaches that of the surrounding water. As discussed in detail below, an electrolyzer assembly 120 integral with the assembly 2 can pressurize the stationary tube 20

The generator tube assembly 18 is moved upward by ascending wave motion and downward by gravitational force when float 4 descends into a passing wave trough. Charged conductors or rings 22 produce an electrostatic field that repels like charges in circumferential conductors or rings 50, 52, which are spaced apart from one another and insulated by dielectric tube 20. Conductors 50 and 52 may be connected in any desired way to produce electricity including the parallel connections shown in FIG. 2. Repulsion of like charges provides centering of tube 18 within 20 and establishes a low-friction electro-repulsive bearing regarding relative motion of 18 within 20.

In certain embodiments, the circuit of 50, 52, and the transformer primary winding of 56 may be charged with the same charge and voltage as carried by 22. Illustratively, charging rings 22 with electrons at a suitable voltage, such as 7,200 volts; and the circuit of 50, 52, and the primary of transformer 56 with electrons at a potential of 7,200 volts, results in accumulation of electrons at zones 52 at the time that the system is in the position shown in FIG. 2. As wave force moves conductors or rings 22 of the generator tube 18 to the proximate position of rings 50 of the stationary tube 20, and alternately to 52 of the stationary tube 20, the electrons leave 50 and load 52 and vice versa to produce the desired alternating current in the primary winding of transformer 56.

The spacing of conductors 50 and 52 develops an alternating voltage potential in the moving field of permanently charged ring(s) 22 that causes a current flow that alternates between conductors 50 and 52 as tube 18 moves up and down within tube 20. For most applications, it is preferred to make the gap spacing of rectilinearly reciprocating conductors 22 and stationary conductors 50 and 52 as close as possible with respect to rings 22 within the operating limits regarding the dielectric strength of insulating tubes 18 and 20. In this regard, in certain embodiments a polyolefin such as polyethylene, polypropylene or polymethylbutene may be used for tubes 18 and 20, and/or to laminate a similar polyolefin to the surface of tube 18 and to the surface of tube 20 for the purpose of protecting conductive metal rings 22, 50, and 52 from corrosion or parasitic discharge. This lamination also seals these electrical components against corrosion. In other embodiments, all outside surfaces of the polyolefin assembly can be treated with fluorine during the manufacturing process to produce surface zone of fluropolymer with a lower coefficient of friction and to cause these surfaces to be in a state of compression.

In certain embodiments, the alternating electrical current frequency is the same as the frequency of the wave motion multiplied by the number of conductors 22 per height of the wave. The width and longitudinal spacing of conductors 22 for optimizing conversion of wave energy into electricity is largely dependent upon the surface and volume resistivity along with other dielectric strength characteristics of polymer tubes 18 and 20. Exceptionally high dielectric values are available in thin films of polyolefins in which it is common to achieve 2,000 to 6,000 volts/mil along with at least 10¹⁶ ohms surface resistivity compared to less than 500 volts/mil dielectric strength and less than 10¹⁵ ohms surface resistivity in injection molded or extruded material with thicker walls. In one embodiment it is preferred to make tubes 18 and 20 as composites in which at least two thin layers of 0.003″ polyethylene tubings that are interference fit by control of internal pressure at the time of blow forming and orientation, coated with silver or copper in thin layers at the locations shown as 22, 50, and 52, and then supported by thicker support tubes that are placed on the sides that have been plated with bands 22, 50, and 52 to form the assemblies of tubes 18 and 20 as illustrated in the Figures.

Another embodiment utilizes at least two thin layers of 0.003″ polyethylene tubing which are interference fit by control of internal pressure at the time of extrusion blow forming and orientation. Each composite is sized for low-friction running fit of generator 18 within stationary tube 20 and coated with aluminum, silver or copper in thin layers at the locations shown as 22, 50, and 52. Tube 20 is then coated with a suitable adhesive, assembled, internally pressurized, and conformed to cylindrical support tube 14 with the result of developing circumferential grooves between bands 50 and 52. Thin-walled composite tube 18 can be bonded to fitted end disks 17 and 19 and the top disk 17 is attached to the rod 9 as shown. In operation, the circumferential grooves in 20 stabilize the gas bearing that results in the annular space between generator tube 18 and stationary tube 20. Moreover, annular grooves between rings 50 and 52 can also provide gas bearings. Appropriate clearance seals, drain galleries and ports, and feed ports are provided to these bearings to eliminate undesired friction and dynamic instabilities.

This low-friction and high performance dielectric design enables close packing of rings 22, 50, and 52 and the use of a transformer to produce the desired voltage for inexpensive transmission to shore for grid distribution or to dedicated industrial applications. Providing close axial spacing of generator rings 22, 50, and 52 also increases the rate at which work is done in forcing electrons back and forth in the circuit shown. High power level per pound of materials results for the components of the invention which is much more attractive than in conventional approaches to wave-energy conversion.

Another embodiment utilizes at least two thin layers of 0.003″ polyethylene tubing which are interference fit by control of internal pressure at the time of extrusion blow forming and orientation. Each composite is sized for a low-friction running fit of 18 within 20 and coated with aluminum, silver or copper in thin closely spaced layers at the locations shown in the arrangements noted as 22, 50, and 52. Tube 20 is then placed on a suitable gas bearing mandril, the gas bearing is relaxed to collapse 20 on the mandril, coated with a suitable adhesive and fitted with at least two additional conformal 0.003″ wall polyolefin tubes with the result of developing conformal seals to bulkheads 12 and 16. Thin-walled composite 18 is interference fitted to a glass billet or heavy-walled symmetrical nipple which is attached to 9 as shown. In operation, low-friction centering of generator tube 18 within stationary tube 20 is due to the electrostatic and gas bearing forces previously noted.

The arrangement of electrical current-inducing components 21, 22, and 23 may be as shown for production of alternating current with delivery as shown by two conductors 63 and 65, or the system may be configured with equal numbers of current rings with appropriate spacing for production of three-phase alternating current.

In many applications it is preferred to transport substantial quantities of electricity as alternating current on appropriate grids or conductors 63 and 65 and at various locations to convert some portion of the alternating current to direct current as shown with full wave bridge 58 for efficient delivery of DC electricity through conductors 60 and 62. Controller 64 monitors the wave height, form, and frequency as a function of the frequency and timing of the alternating current in transformer 56. This information is used to adaptively control the operation of the assembly 2 for maximizing conversion of wave energy into electricity.

In certain embodiments it is possible to maintain a suitable gas pressure within stationary tube 20 to assure heat transfer rates sufficient to cool tube assembly 18 and to provide a gas bearing function to minimize drag during the motion of generator tube 18 within stationary tube 20. Tube or nipple ends 17 and 19 are preferably chamfered as shown to provide loading of gas bearing surfaces between the inside diameter of stationary tube 20 and outside diameter of generator tube 18.

In instances that additional mass is needed for returning generator tube 18 from upward excursions, it is preferred to make end portion 19 from a heavier material, such as a lead-antimony or steel alloy such as 410 SS, and to make end portion 17 from an engineering polymer or aluminum alloy for purposes of creating a righting force on cable 6 and rod 9 as it is guided through anti-friction bearing 12 which is preferably made from a self-lubricating material such as WearComp from HyComp Inc., 17960 Englewood Drive, Cleveland, Ohio 44130-3438.

A suitable gas for pressurizing the interior of 20 is hydrogen which may be generated as needed by an electrolyzer assembly 120 including electrolyzer electrodes 28, 29 in lower chamber 30. The hydrogen may be admitted to the chamber within 20 through filter 46, solenoid valve 44, and filter-regulator 42 as shown. It is preferred to provide a filter media within 42 that prevents water and other liquids from entering stationary tube 20 and which neutralizes any acid/base particles or fumes. The electrolyzer assembly 120 can be driven by at least a portion of the electricity produced by the relative movement of the generator tube 18 and the stationary tube 20.

In certain embodiments, it may be suitable to locate heavier components such as electrolyzer 28 at the lower portion and lighter components such as coaxial tubes 18 and 20 in the upper portion to produce the vertical orientation of components as shown. This improves the efficiency of operation by keeping tubes 18 and 20 aligned with the lifting and descending forces produced by wave action and gravity. In many instances it is beneficial to connect unit generators along with additional units by more or less horizontally positioned tension cables to create a network that is stabilized against traveling or bunching due to wind or wave motion. Further stabilization may be provided by tension cables to anchors at the ocean floor or other structures at outer borders or to the leading and tailing edges of arrays that are thus created to withstand horizontal travel due to wind and wave forces.

In certain embodiments, a controller 64 regulates the pressure of the hydrogen atmosphere created by the electrolyzer 28 within stationary tube 20. For example, in some embodiments the controller can regulate the pressure of the hydrogen or other gases to produce the optimum relationship of minimizing the drag of generator tube 18 within stationary tube 20 while maximizing electrical energy production. Increasing the hydrogen pressure increases heat transfer from generator tube 18 through stationary tube 20 to the surrounding water and produces less drag by slightly expanding the diameter of stationary tube 20. However this reduces the electrostatic field strength of plates 22 on 52 and 50, which in turn reduces the repulsive voltage in the circuit of 50 and 52. Controller 64 can adaptively control the pressure within stationary tube 20 to optimize these counteractive effects while operating the system within prescribed limits. This enables very inexpensive materials to be selected and used with virtually unlimited lifetimes in greatly varying conditions including wave height, wave frequency, and ambient temperature.

In certain embodiments, the illustrated energy conversion assembly 2 can operate in water that is deep enough to place the generator assembly at a depth of at least 100 feet or more below the surface where float 4 is operated for the purpose of minimizing exposure to storms and passing ships. In other embodiments, however, the assembly 2 can be positioned at a depth that is less than or greater than 100 feet. Hydrogen in lower chamber 30 and at a lesser pressure within stationary tube 20 is adaptively adjusted to provide rigidity to the tube generator assembly and provide buoyancy for tensioning base cable 32 against anchor 34 which may be a weight, expanding barb, or another suitable means of tensioning base cable 32. At times that storms or passing ships threaten to damage the float 4 and cable 6 assembly, motorized tensioner 74 can shorten the base cable 32, and the electrolyzer 28 can be turned off along with opening solenoid valve 44 and solenoid valves 36 and 40 to flood chamber 30 with sea water which has been filtered by filter assembly 38. These actions cause the system to pull 4 downward to a position below harms way. When it is safe to reestablish normal operation, electrolyzer 29 generates hydrogen within 30 to lift the system as tensioner 74 releases the base cable 32 to establish the normal operating position of the float 4 at the ocean surface. Tensioner 74 can be adaptively operated to adjust the relative positioning of the 4 with respect to the surface for optimum conversion of wave energy to electricity.

It is anticipated that larger requirements for energy would be provided by using a long float designed to best harness energy in the types of waves prevalent at the location of application with numerous individual energy conversion units attached to it. Where needed, it is intended that such long floats or individual unit floats would be connected by cables attached in patterns that prevent substantial horizontal travel of the floats due to wind or water currents. Such cables could provide tethers as needed to prevent motion in any given horizontal direction and include arrays based on hexagonal, square, circular and other patterns for spacing the wave generators.

Because the generator assembly 2 is vertically and coaxially self centering and provides a high yield of electrical energy per mass of required materials, in certain embodiments it may be preferred to design tube assemblies 18 and 20 for waves that are 5 meters or more. In other embodiments, however, smaller waves are also within the operational envelope as controller 64 can adaptively adjust the tension on base cable 32 to optimize energy conversion efficiency regardless of the prevalent wave height. This enables the system to operate in extreme conditions of high and low wave amplitudes with the capability of efficiently utilizing the maximum amount of wave energy available to produce electricity.

For purposes of hydrogen generation, in one embodiment it is preferred to operate electrolyzer electrodes 28 and 29 of the electrolyzer assembly 120 at a voltage only sufficient to liberate hydrogen from 29 but not chlorine or oxygen from 28. However, when biofouling threatens to become a problem, in other embodiments it may be preferred to increase the voltage applied to electrolyzer electrodes 28 and 29 to the point of producing chlorine along with hydrogen from filtered seawater. This chlorine is kept separate from the hydrogen by use of a semipermeable membrane or divider 27 and is distributed from cavity 30 through valve 40 to delivery tube 75 to annular distributor tube 76 which is perforated in the annular portion at the bottom of the assembly as shown to create a chlorine or ozone-rich atmosphere to dispel biomass agents from the assembly. After chlorine is depleted from the electrolyte in electrolyzer 29, oxygen is produced. The electrolyzer assembly 120 can include features that are generally similar in structure and function to the corresponding features of electrolyzer assemblies disclosed in U.S. patent application Ser. No. 12/707,651, filed Feb. 17, 2010, entitled “ELECTROLYZER AND ENERGY INDEPENDENT TECHNOLOGIES,” U.S. patent application Ser. No. 12/707,653, filed Feb. 17, 2010, and entitled “APPARATUS AND METHOD FOR CONTROLLING NUCLEATION DURING ELECTROLYSIS;” and U.S. patent application Ser. No. 12/707,656, filed Feb. 17, 2010, and entitled “APPARATUS AND METHOD FOR GAS CAPTURE DURING ELECTROLYSIS,” each of which is incorporated herein by reference in its entirety.

In instances that it is desired to manage heat transfer from generator tube 18 and or stationary tube 20 to the surroundings, the atmosphere within stationary tube 20 may be selected from the group consisting of high conductivity, low viscosity gases such as hydrogen and helium; low conductivity gases such as argon and chlorofluorocarbons, and the pressure and composition of any selected atmosphere may be adjusted for purposes selected from the group consisting of: reducing friction losses, increasing or decreasing heat transfer, producing structural rigidity for the system assembly, and managing buoyancy.

In certain embodiments, the electricity generated by the assembly 2 can be used to ionize oxidants such as oxygen or chlorine to increase the reactivity as an anti-biofouling agent before release through distributor 76. Suitable methods for ionizing these gases include spark discharge and ultraviolet lamps operating on the supply circuit shown. Additional transformers may be connected in parallel with the primary or secondary of transformer 56 and utilized to produce the desired voltages for electrolyzer 28 and ionizer 31 as needed.

In addition to controlling the pressure within 20 and 30, controller 64 utilizes suitable instrumentation such as doppler or optical electronics or spring 70 and 72 at the ends of tube chamber 20 to monitor the length of travel of 18 within 20. Biasing members or springs 70 and 72 can include integral sensors. Moreover, springs 70 and 72 have multiple functions including sensing the travel path of 18 within 20, serving as a shock absorber if necessary, and recovering kinetic energy as the motion of generator tube 18 is reversed. It is desired to allow full motion of generator tube 18 with the wave height that is available up to a design limit at which the motion is safely stopped by the arrangement shown until the wave crest passes. Accordingly, controller 64 evaluates the range of motion of generator tube 18 within stationary tube 20 and if spring-sensor 72 is being deflected and 70 is not, controller 64 will move the outer tube assembly downward by shortening cable 32 by winding it on the cable spool of motorized tensioner 74 as shown in FIG. 1. If spring-sensor 70 is being deflected and 72 is not, cable 32 is lengthened until 18 is suitably centered within 20.

In certain embodiments, a small hydrogen fuel cell or battery charger and battery pack 78 is utilized to store energy as a small portion of the energy generated and allow operation of controller 64, tensioner 74, valves 38, 40, 44, and to provide instrumentation and control communications from 64 through a radio antenna in 4 to a central control station on land or on service boats that occasionally maintain the wave generators. Fuel cell 78 and controller 64 are available for service by a diver and can be easily replaced if necessary for activation of units that have been stored in the submerged state for extended periods.

Thus controller 64 optimizes the operation by controlling the hydrogen pressure within 20 and 30 in addition to controlling the position of the floatation unit 4 with respect to the generator tube 20 and to the ocean surface for the purpose of converting as much of the wave energy into electricity as possible. Still another function of controller 64 is to monitor biofouling conditions and to control electrolyzer for production of chlorine as needed to dispel marine organisms that cause biofouling.

Application of the principles of the present disclosure facilitates many variations in which desired energy conversion, frequency multiplication, or phase transformation may be accomplished by application of a first force that is utilized to cyclically develop a substantially rectilinear force upon a moveable component 18 that incorporates electrically separated zones 22 that are electrostatically charged for the purpose of inducing the flow of electric current in a suitable conductor including an electrical load such as motor winding or electric light filament or semiconductor device or the primary of a transformer 56 connected between electrically separated zones 21 and 23 that are incorporated in a stator or stationary tube 20 that is proximate to the moveable component incorporating zones 22, and wherein said moveable component 20 is cyclically moved in a direction substantially opposite of the first force by a force selected from the group including a mechanism, an opposed piston engine assembly, gravity, spring action, and compressed gas force. Thus the generator assemblies 2 disclosed herein may be applied in a horizontal, vertical, or any other desired orientation in which cyclic forces other than wave action and gravity are applied. Illustratively, it is contemplated that the first force may be produced by the action of a piston in a Stirling or internal combustion engine (ICE) and the restoring force may be produced by a compressed gas, spring, an opposing piston of the same or another engine or a suitable mechanism such as a crank shaft or swash plate that cyclically converts the kinetic energy of a flywheel into restoring work.

Another embodiment of a wave-generator assembly 80 is shown in the schematic view of FIG. 3. In the illustrated embodiment, permanent magnets (M₁ and M₂) or electro-magnets 82 and 84 are added to the assembly 2 of FIGS. 1 and 2 to create a magnetic field that is substantially perpendicular to the circumferential insulated turns of conductor 86 that connect each set of annular rings 88 and 90 as shown. In certain embodiments, rings 88, 90, 92, and 94 may be split as shown to depress eddy currents. In operation, current alternates between typical rings 88 to 90 as a function of the wave-forced motion of electromagnetic fields such as from 82 and 84 and electrostatic fields from rings such as 92 and 94 as disclosed with respect to the embodiment of FIGS. 1 and 2. Supplemental inducement to the current in coil(s) 86 is from the magnetic field that is established between magnetic poles 82 and 84 as shown.

In applications where it is desired to minimize internal friction and parasitic losses, it is preferred to design outer tube 100 for withstanding the pressure forces of the ocean with only sufficient gas pressure to assure adequate cooling of internal parts. For this purpose, the outer tube 100 may be made from glass, marine aluminum such as 5086, or a low alloy steel such as 4140 with anti-fouling coatings on exposed surfaces. In this instance the program controller 64 can be programmed for use in either the embodiment of FIG. 2 or 3 to provide hydrogen pressure sufficient to cool the internal components sufficiently to optimize resistive losses along with protecting against material degradation while minimizing losses due to gas drag. This results in much lower hydrogen gas pressures because it is not necessary to cancel crushing forces with internal pressure.

Referring to FIGS. 1-3 together, another embodiment of the disclosure is provided by utilizing dielectric materials for composite tubes 18 and 20 that offer much higher use temperatures than the polyolefins. Resins such as polyetherimide, polyethersulfone, and polysulfone are stable at 330° F. (165° C.) or higher and in thin wall film thicknesses of 0.005″ or less provide dielectric strengths of 2,400 to 4,400 volts/mil. This allows the hydrogen (or another gas) pressure within 20 to be lower and results in lower gas-drag losses while the system operates at the higher steady-state temperatures made possible by these materials. It is preferred to utilize higher conductivity materials such as silver or gold with this embodiment for thin platings of rings 22, 50 and 52.

One significant application of the disclosure is conversion of mineralized feed stocks and ore concentrates to metals, valuable non-metals such as oxygen, halogens, methane, and other refined materials. Illustratively, application of direct-current electricity from rectifier 58 as delivered from conductors 60 and 62 through appropriate electrolysis cell 120 provides products such as hydrogen; or halogens such as chlorine, iodine, and bromine; or oxygen; or reactive metals such as sodium, potassium, magnesium, titanium, manganese from non-aqueous electrolytes; or transition metals; or heavy metals including precious metals. In this embodiment a substantial portion of the electricity produced is applied to electrolysis cell 120 for the purpose of generating metals and non-metals from appropriate concentrates that contain these elements.

In ocean energy conversion and mining applications it is especially important to prevent sludge build-up, biofouling, and contamination of ocean environments by preventative use of halogens such as chlorine to prohibit degradation of the components of the disclosure and accumulation of biomass and/or sludge that would pollute of the ocean environment.

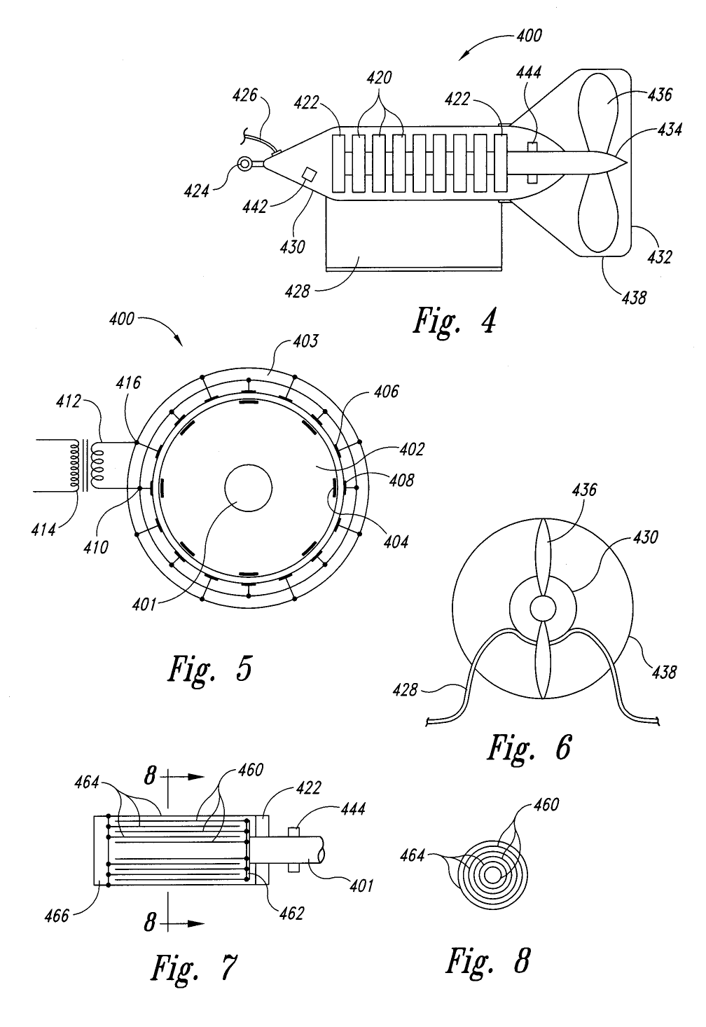

Generation of electricity from forces found in wind and falling water such as streams and tides can also be harnessed by the present energy conversion and delivery regime. The following description with reference to FIGS. 4-8 is for in-stream applications but applies generally to wind applications as well in which propeller 436 is of the appropriate diameter, pitch, etc., for the prevailing wind conditions. More specifically, FIG. 4 is a cross-sectional side view of a rotary generator assembly 400 configured in accordance with an embodiment of the disclosure for converting energy in moving water into electricity. FIG. 5 is a schematic diagram of components of the rotary generator assembly of FIG. 4, and FIG. 6 is a schematic end view of the rotary generator assembly of FIG. 4. Referring to FIGS. 4-6 together, the rotary generator assembly 400 includes a rugged water tight housing 430 within which are incorporated a suitable generator assembly 420 which may be repeated or cascaded as shown in the illustrated embodiment to produce the torque and electricity conversion desired and one or more anti-friction support bearings 422. Generator assembly 420 is driven by a suitable motion driver device such as propeller 436 attached to drive shaft 434 as shown and housed by shrouds 432 and 438. A suitable seal 444 prevents loss of atmosphere from housing 430 to the outside area and inward passage of the exterior atmosphere. In certain embodiments a small portion of the electricity produced by the assembly 400 is utilized to electrolyze water in electrolyzer 442 for the purpose of filling the interior space of housing 430 with hydrogen at an adaptively controlled pressure to remove heat from generator 420 and/or transformer 412, 414 and to reduce the windage losses due to viscosity and friction of the atmosphere within housing 430. Operation of electrolyzer 442 is generally similar as described above regarding electrolyzer 120 along with associated controls. Moreover, electrolyzer 442 can include features that are generally similar in structure and function to the corresponding features of electrolyzer assemblies disclosed in U.S. patent application Ser. No. 12/707,651, filed Feb. 17, 2010, entitled “ELECTROLYZER AND ENERGY INDEPENDENT TECHNOLOGIES,” U.S. patent application Ser. No. 12/707,653, filed Feb. 17, 2010, and entitled “APPARATUS AND METHOD FOR CONTROLLING NUCLEATION DURING ELECTROLYSIS;” and U.S. patent application Ser. No. 12/707,656, filed Feb. 17, 2010, and entitled “APPARATUS AND METHOD FOR GAS CAPTURE DURING ELECTROLYSIS,” each of which is incorporated herein by reference in its entirety.

The illustrated embodiment can also include a reinforcing shroud or wire-form cage 438 around propeller 436 to keep debris, rocks, marine life, etc., from colliding with propeller 436. The assembly can also be elevated by a suitable base or stand 428 as shown in FIGS. 4 and 6 to provide the desired location above the stream bed or ocean floor to take advantage of the best currents and to prevent propeller 436 from striking the stream or ocean floor. A chain or cable attached to 424 secures the generator unit to the desired location of a stream or ocean site. Electricity produced by generator 420 is taken to land by insulated cable 426 generally as shown in FIG. 4 to be used for replacement of electricity from non-renewable sources such as fossil and nuclear fueled power generation stations and to make hydrogen for any desired energy storage, chemical, or power production application.

While any desired generator may be selected for such applications it is preferred to utilize the weight conserving materials shown in the magnified schematic circuit of embodiment 400 in FIG. 5 for smaller applications. As shown in the illustrated embodiment, a first generator subassembly or rotor 402 is driven by shaft 401 in more or less constant velocity rotation while the wind blows, tide flows, or a stream or current runs and may be provided with reverse pitch capabilities to operate in reverse flow such as provided by tides. Rotor 402 can be constructed of a high electrical resistance material such as ceramic, thermoplastic or thermoset polymer, with conductor sections or strips 404 of conductive material on or near the outer rim of rotor 402. These conductors 404 are spaced apart but electrically connected as shown. Conductors or conductive zones 404 receive a maintained electrical charge such as electrons or the absence of electrons as may be produced by charging to the desired voltage.

Rotor 402 rotates relative to a second generator subassembly or stator 403, which includes multiple spaced apart stationery conductors or conductive zones 406 and 408. More specifically, as the rotor 402 rotates to the position shown in FIG. 5, stationary conductive zones 408 are depleted of electrons because of like-charge repulsion. Electrons leave zones 408 and travel in the collection circuit shown to junction 410, which is connected to a suitable load or device such as the transformer primary 412. Electrons leaving primary 412 are then delivered to interconnected zones 406 through connection 416. Rotor 402 continues to rotate and conductors or conductive zones 404 to pass near stationery zones 406 to repel the electrons collected there. Repelled electrons pass back through connection 416 to primary 412 and then to conductive zones 408. This cyclic displacement of charge continues as the rotator 402 rotates. It is generally preferred to charge the stationery circuit connected to primary 412 to a relatively high voltage and to the charge rotor zones 404 with high voltage to assure a satisfactory current density in the stationery circuit shown.

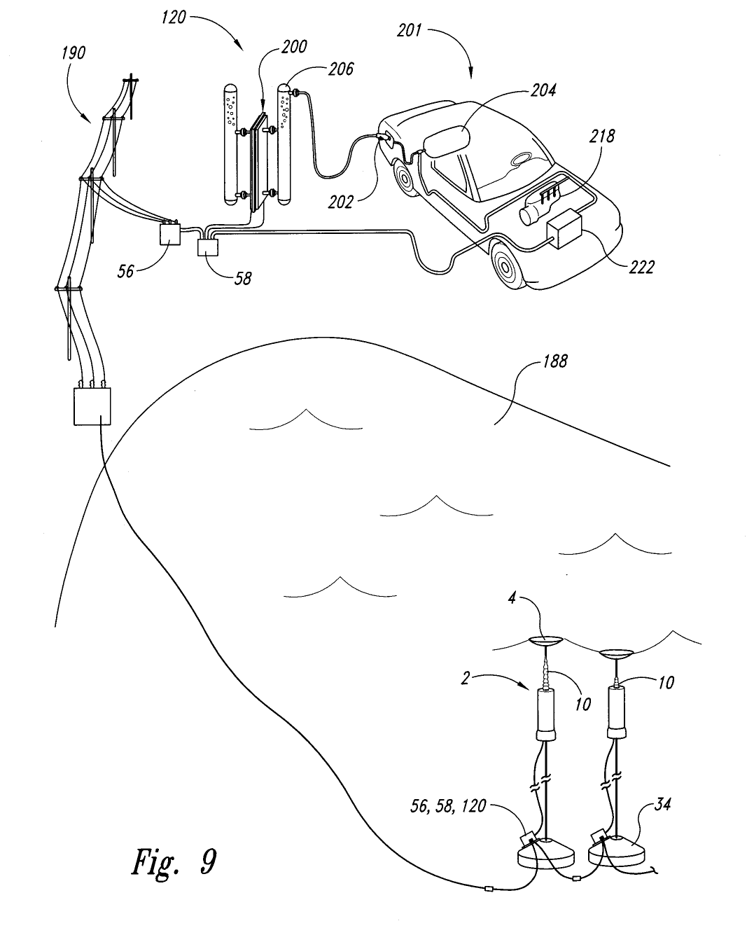

In certain embodiments, a number of such generators 420 can be used in appropriate orientations that stagger these electricity producing events to provide three-phase electricity for delivery in the regime shown in FIG. 9. In remote applications, however, it is generally preferred to utilize direct current provided by suitable rectifiers or to incorporate an inverter to provide desired conditioning of electricity. Depending upon the voltage carried in the rotors, higher strength dielectric gases may be utilized to insulate the charged zones of generator rotors 402. Gases suitable for this purpose include fluorinated sulfur and halogenated hydrocarbon gases.

In instances that the energy available in moving water or wind is adequate it is possible to increase the density and thus the torque rating of a generator assembly within housing 430 by use of the multiple concentric cylinder arrangements. For example, FIG. 7 is a schematic side view of a rotary generator assembly configured in accordance with another embodiment of the disclosure, and FIG. 8 is a schematic cross-sectional view taken substantially along lines 8-8 of FIG. 7. Referring to FIGS. 7 and 8 together, drive shaft 401 is rotated or torqued by suitable propeller 436 and is sealed within housing 430 by seal assembly 444. Bearing assembly 422 provides support, anti-friction rotation, and centering of multiple spaced apart and concentric rotor shells 460 that are attached to drive shaft 401 by disk 462. The generator further includes multiple spaced apart and concentric stationary shells 464 that are held in place by disk 466 which may incorporate a bearing for supporting an extension of drive shaft 401. Rotating cylindrical shells 460 have spaced apart conductors or metal longitudinal strips that are kept permanently charged as described regarding the schematic circuits disclosed regarding FIG. 5. Stationery cylindrical shells 464 have longitudinal conductors or strips 408 and 406 that are spaced apart generally as shown in FIG. 5, and that alternately source and receive electrons that are repelled by charged strips 404 as they rotate to close proximity. The current created between zones 406 and 408 may be applied to any useful load including those in which power conditioning is provided by a suitable inverter or current transformer 412 and 414 as shown in FIG. 5.

Utilization of multiple concentric non-contacting cylindrical shells of suitable length allows the generator diameter to be minimized for purposes of conserving material and for reducing drag and turbulence in the wind or water stream that drives the unit. Moreover, permanently charging longitudinal zones like 404 as shown in the end view of FIG. 5 on rotor 460 greatly reduces the complexity and expense compared to conventional approaches with brushes or permanent magnets to produce the desired generator functions.

Materials suitable for construction of shells 460 include thermoplastics, thermosets, glass, ceramic, and composites that are stiffened by high modulus fiber reinforcements. Similar materials may be chosen for stationery cylinders 464. Protective case 430 may be constructed from materials such as thermoplastics, thermosets, steel, aluminum, glass, ceramics, and composites that are stiffened by high modulus fiber reinforcements. Charged strips 404 may be thin layers of aluminum, nickel, copper, silver, gold or other suitable selections for holding dense charges such as electrons. Similar materials may be used in the thickness needed for strips 406 and 408 to produce the currents desired at the resistance allowed in the application. In other embodiments, however, the features of the present disclosure allow the conductors 404, 406, and/or 408 to not include copper.

The invention of converting reciprocating motion from any suitable source into electricity and use of such electricity along with electricity from conventional sources in an energy conversion regime with production, storage, and transportation of hydrogen in an existing natural gas infrastructure, including storage in underground geological structures and transport in existing pipelines, provides favorable economics for replacement of 60 billion barrels of oil used daily with renewable energy.

For example, FIG. 9 is a schematic illustration of an embodiment of the disclosure for converting a renewable energy source, such as water energy, into electrical energy, electrical energy into chemical energy, and convenient delivery of hydrogen and or oxygen to a vehicle and other energy consuming applications. FIG. 9 illustrates an application of some of the method and apparatus embodiments described above with reference to FIGS. 1-8. For example, the generator assembly 2 described above with reference to FIGS. 1-3, as well as any other generator assembly described herein, can be deployed in relatively deep water spaced apart from a shore line 188. The generator assembly 2 can be coupled to a portion of an electricity distribution grid 190 to deliver the generated electricity to a transformer 56, a rectifier 58, an electrolyzer assembly 120, and ultimately an energy consuming device such as a vehicle 201.

In applications that it is desired to cleanly and sustainably operate homes, factories, farms, and/or motor vehicles from solar-derived wave energy, an embodiment similar to that shown in FIG. 2 may be used. Applications include electric lighting, electric tools and appliances, microwave cooking, microwave communications, electric motor drives, induction heating, electromagnet drives, electrodialysis, electro-separation of metals from ores, electro-separation of hydrogen from water, and electric-arc devices.

Providing motive energy for vehicles will be used to illustrate such applications, although other energy consuming apparatuses are within the scope of the present disclosure. Grid electricity 190 produced by wave energy conversion and/or other sources is delivered at the desired voltage to the point of refueling a vehicle 201. Electric current is delivered by a suitable delivery circuit or grid 190, which includes appropriate transformers, switch gear, circuit breakers, fuses, electricity conductors, meters, capacitors, resistors, and inductors. At the point of refueling a vehicle 201, suitable transformer 56 and rectifier circuit 58 provides the desired direct-current and voltage for operation of water electrolyzer 120 to produce pressurized hydrogen. It is preferred to utilize the type of electrolyzer 200 as shown in FIG. 9, which produces and delivers hydrogen at the desired pressure by quick fill valve assembly 202 to a suitable storage tank of a vehicle 204 as shown. Hydrogen from pressurized storage in tank 206 can be quickly transferred to refuel a vehicle. In the instance that the vehicle 201 is powered by an internal combustion engine 218, it is preferred to utilize the spark-injection fuel metering and ignition system disclosed in copending patent application Ser. No. 08/785,376, which is incorporated herein by reference in its entirety. In certain embodiments, a carbon or glass fiber reinforced composite hydrogen storage tank can be used such as those provided by manufacturers such as Lincoln or Structural Composites Industries (SCI).

In instances that the vehicle 201 utilizes a fuel cell engine 222, including arrangements in conjunction with a flywheel or heat engine in a hybrid propulsion system, a reversible fuel cell 222 may be used as shown in FIG. 9. In this embodiment, such a reversible electrolyzer/fuel cell 222 can be positioned on-board the vehicle 201 to produce hydrogen and oxygen from water when it occasionally consumes electricity from the grid 190 as shown, and/or in the regenerative deceleration of the vehicle. In the reversed mode it serves as the fuel cell for electricity generation for one or more traction motors, acceleration of hybrid flywheels and for other electricity requirements.

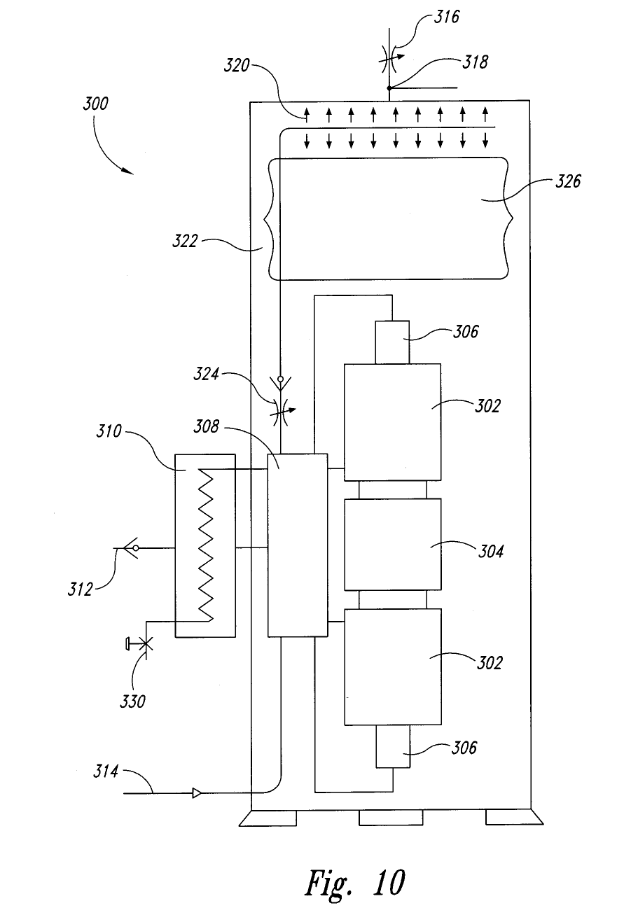

FIG. 10 is a schematic view of a generator assembly 300 configured in accordance with a further embodiment of the disclosure. More specifically, FIG. 10 is a combination linear generator and a linear motion prime mover, such as an opposed piston internal combustion engine or an external combustion engine such as a Stirling, Schmidt, or Ericsson cycle engine. For example, FIG. 10 illustrates one embodiment of a generator assembly 300 for receiving hydrogen and/or methane that has been distributed through a conduit such as a natural gas line or delivered by the storage system disclosed in my co-pending patent application concerning densified storage of fluids which is incorporated herein as part and parcel of this disclosure. The embodiment illustrated in FIG. 10 efficiently converts the fuel potential energy into electricity and heat for on-site uses at outlets 312 and 318.

A particularly efficient system for storage and pressurization results from the combination of SIFT (e.g., filter 250 described in detail below) generator assembly 300 heat recovery unit 310. A fuel or substance such as hydrogen is purified and pressurized by SIFT unit 250. Further storage for mobile or compact storage applications along with pressure increase is provided as needed, in addition to heat addition, voltage application, or vibration absorption by assembly 310.

One or more suitable heat engines 302, such as an opposed piston type with pistons and cylinders with appropriate intake valves or ports, drives a linear generator 304 preferably having several of the features of the generators described above with reference to FIG. 1-9. In certain embodiments, an integrated injector/igniter can be used for a combination of instrumentation, fuel injector, and ignition system 306 disclosed in U.S. patent application Ser. No. 08/785,376 which is incorporated herein by reference in its entirety and which provides a particularly efficient method for burning hydrogen and/or hydrogen-characterized fuels in internal combustion engines. In this application, the SmartPlug devices 306 can sense the position and acceleration of the pistons to provide adaptively controlled proportioning and timing of fuel injection and ignition events.

Engine fuel, which can be hydrogen or hydrogen-characterized fuel constituents, is prepared in thermochemical regenerator 308 which has inputs of the engine exhaust and/or engine coolant and can have input of fuel from any suitable source including preferred storage in adsorptive storage 310 and outputs of heated water for domestic purposes such as bathing, clothes washing and space heating. The construction, internal circuits, and operation of the preferred thermochemical regeneration system 308 is found in copending U.S. patent application Ser. No. 08/785,376, which is incorporated herein by reference in its entirety.

Piston, cylinder, and valve or port assemblies 302 may be of two or four stroke designs and operation. Air is taken in, compressed and heated by fuel that is injected and ignited by injectors 306. Work is done by expanding the heated gases of combustion along with preferred excess air that insulates stratified charge fuel combustion during the power cycle of the engine. The work product of the engine is converted into electricity by linear generator 304 and into potential energy as air is compressed in the opposing piston and cylinder 302. After the opposing piston in its cylinder reaches the degree of compression adaptively controlled for optimization, fuel is injected and ignited by 306 to continue the power cycle of the opposed piston operation.

Linear generator 304 provides the desired frequency, voltage, and current by the principles disclosed with respect to FIGS. 1-9 and/or other embodiments disclosed herein. In certain embodiments, it is possible to house engine 302 and integral linear generator 304 within a water heater canister 322 for purposes of noise attenuation and regenerative heat recovery for an extremely efficient domestic hot water supply. City or pressurized well water 314 enters the thermochemical regenerator 308 as shown and after receiving heat not converted into electricity by engine-generator assembly 302/304, is delivered across combination pressure regulator and check-valve 324 to hot water distributor 320. In certain embodiments, the hottest water from cooler can be segregated from more slowly heated water for purposes of fast response to hot water demands. Pressure relief valve 316 protects against dangerous over pressurization. Hot water delivered to distributor 320 is added to tank 322 at low velocity by outlets in 320 that cancel net circulatory momentum of the entering water. Further segregation of hottest water from more slowly heated water can be performed by a very low cost bundle of parallel vertical tubes 326 that prevent convection cells from forming. A polymer honeycomb structure of thin-walled cross-linked polyethylene or polypropylene can be used for ease of manufacture of 326.

Primary fuel enters adsorptive storage canister 310 and is released to be combusted in engine 302 on an optimized adaptive basis by SmartPlugs 306. Exhaust from 302 is transferred to 308 for thermochemical regeneration or heating incoming domestic water as needed. Further cooling of the exhaust in 310 provides condensation of distilled-quality water that is available at 330 as shown.

In order to rapidly extend the low cost electricity and hydrogen produced by the disclosed embodiments to the public, one embodiment of the present disclosure includes providing the electricity delivery through existing electric grids and hydrogen delivery along with natural gas in existing natural gas lines. In instances that substantially pure hydrogen is needed to maximize water production or to minimize emissions of carbon compounds such as carbon monoxide, hydrocarbons, or carbon dioxide, transporting hydrogen can be intermingled with natural gas constituents for delivery through existing natural gas lines and to separate the hydrogen at or near the site of application. As described in detail below, separation of relatively small amounts as might be needed for producing the electrical and heat energy for a home or small business is performed by a membrane filter that selectively passes hydrogen.

Various embodiments of the disclosure combine to provide an energy conversion regime in which the most plentiful available sources such as wave energy, wind energy, falling water, tidal energy, and biomass energy are converted into electricity for meeting instantaneous load requirements and to power electrolyzers and thermoelectrochemical devices for conversion of surplus electricity into chemical fuel potential energy including pressure potential energy and chemical reaction potential energy.

These embodiments further provide for storage of such fuel potential energy including use of conduits for substantially underground transport of pressurized supplies of fuels such as natural gas, subsurface geological strata that is sufficiently porous to receive substantial supplies of said electrolysis sourced fuel potential energy, subsurface geological caverns, and above surface pressure tanks for storing fuel potential energy as pressurized inventories.

Engine improvements for Stirling, Ericsson, and Schmidt types along with gas turbines, piston engines, rotary combustion engines, and fuel cell engine types are provided by clean, fast, and assured combustion of hydrogen which is selectively filtered where needed from mixtures of hydrocarbon gases such as natural gas by selective ionization filtration technology embodiments which also offer pressurization of such supplies of hydrogen for energy storage or operational advantages as needed. Embodiments include improved heat exchangers that facilitate heating water or air by heat exchange from the exhausts and surfaces of engines and generators used for on-site production of heat, electricity, or shaft power.

Rectilinear generator embodiments for improving the material performances and reducing the complexity, wear characteristics, and life cycle cost of operation are provided for primary and secondary energy conversion purposes in the present sustainable energy conversion regime.

The resulting energy conversion regime provides transport of renewable electricity and pressurized supplies of fuel potential energy by existing networks of electricity grids and or natural gas distribution conduits which are improved by incorporation of occasional placement of systems for selective separation of hydrogen from other ingredients conveyed as mixtures by such conduits. This facilitates commodity transport followed by filter-separated deliveries of hydrogen and hydrocarbons for respective productions of clean energy along with chemicals, fertilizers, polymers, fibers, pigments, pharmaceuticals, foods, and electronics.

Existing natural gas distribution storage and distribution systems are improved by incorporation of occasional addition of hydrogen produced from surplus electricity and/or other forms of surplus energy and selective separation systems for removal of hydrogen from other ingredients typically conveyed by in such natural gas systems. Hydrogen can be supplied at increased pressure compared to the pressure of delivery to said separation systems by application of selective ion filtration technology, pressure swing adsorption coupled with a compressor, temperature swing adsorption coupled with compressor, and diffusion coupled with a compressor. It is generally preferred to supply hydrogen at desired pressure by the selective ion filtration technology (SIFT) embodiment because it requires less energy, reduced maintenance, and lower life-cycle costs to deliver very high purity supplies of hydrogen at the desired pressure.

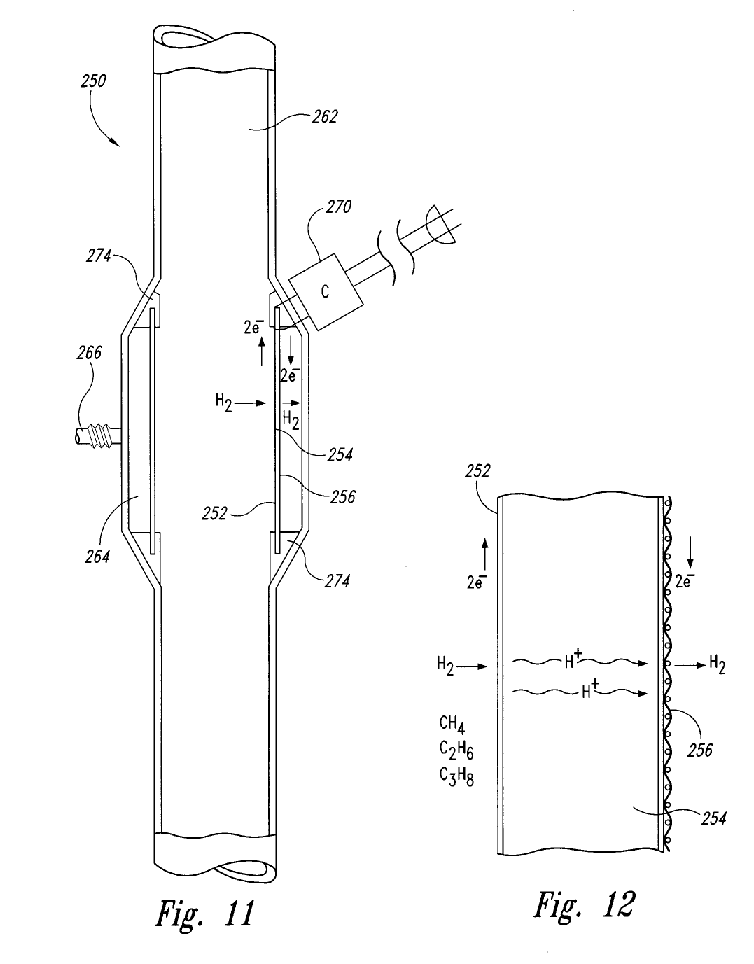

For example, FIG. 11 is a cross-sectional side partial view of a filter assembly 250 including an outcome selective apparatus or filter 254 for selective separation of chemical species. FIG. 12 is an enlarged view of a portion of the apparatus shown in FIG. 11. Referring the FIGS. 11 and 12 together, the illustrated embodiment includes a filtration process in which a suitable filter such as a coaxial filter 254 is concentrically positioned in a conduit 262 that is configured to receive a producer gas, synthesized gas or pipeline mixtures of hydrocarbons such as natural gas and hydrogen 262. As described in detail below, the filter 254 is configured to selectively allow hydrogen to pass through the filter 254 from a first or interior surface 252 to a second or exterior surface 256. In certain embodiments, the filter 254 can be an electrolyzer or filter that is positioned inline with the conduit 262 and that includes corresponding electrodes at the first and second surfaces 252 and 256. Filters or membranes suitable for such filtering include molecular sieves, semi-permeable polymer membranes and palladium and alloys of palladium such as silver-palladium that greatly increase the rate of hydrogen filtration as temperature is elevated. Semi-permeable membranes 254 suitable for application in filter assembly 250 include popular proton exchange membranes (PEMs) of the types used for electrodialysis and fuel cell applications. Insulator seals 274 support and isolate membrane 254 including conductive reinforcement materials 256 on the outside diameter as shown in FIG. 12 as a magnified section. The filter 254 can include features that are generally similar in structure and function to the corresponding features of electrolyzer assemblies disclosed in U.S. patent application Ser. No. 12/707,651, filed Feb. 17, 2010, entitled “ELECTROLYZER AND ENERGY INDEPENDENT TECHNOLOGIES,” U.S. patent application Ser. No. 12/707,653, filed Feb. 17, 2010, and entitled “APPARATUS AND METHOD FOR CONTROLLING NUCLEATION DURING ELECTROLYSIS;” and U.S. patent application Ser. No. 12/707,656, filed Feb. 17, 2010, and entitled “APPARATUS AND METHOD FOR GAS CAPTURE DURING ELECTROLYSIS,” each of which is incorporated herein by reference in its entirety.

In this hydrogen filtration assembly 250, a process called “Selective Ion Filtration Technology” (or SIFT) can be used. Hydrogen is ionized on inside surface 252 for rapid entry and transport in PEM filter 254 as an ion by application of a bias voltage to the PEM filter 254, to which a catalyst may be coated for purposes of increasing the process rates involved. Suitable catalysts include platinum or alloys such as platinum-iridium, platinum palladium, platinum-tin-rhodium alloys and catalysts developed for fuel cell applications in which hydrocarbon fuels are used.

Facilitation of electron removal as ionized hydrogen may be with conductive tin oxide or with a fine screen of stainless steel which is attached to the bare end of an insulated lead from controller 270 as shown. Electrons circuited by another insulated lead as shown to the outside surface of membrane 254 by controller 270 can be returned to hydrogen ions reaching the outside of membrane 254 by a fine stainless steel screen 256 that serves as a pressure arrestment reinforcement and electron distributor.

Electrons taken from the hydrogen as it is ionized are circuited to the outside surface 256 of PEM filter 254. On the “filtered hydrogen” side 256 of the membrane, electrons rejoin hydrogen ions and form hydrogen atoms which in turn forms diatomic hydrogen, which pressurizes annular region 264. The energy expended for this new type of selective-ion filtration and pressurization of hydrogen can be much less than the pumping energy required by other separation and pressurization processes. Controller 270 maintains the bias voltage as needed to provide hydrogen delivery at the desired pressure at port 266 by SIFT processes from mixture 262. Bias voltage generally in the range of 1.5 to 6 volts is needed depending upon the polarization and ohmic losses in developing and transporting hydrogen ions along with pressurization of the hydrogen delivered to 264 by the SIFT assembly.

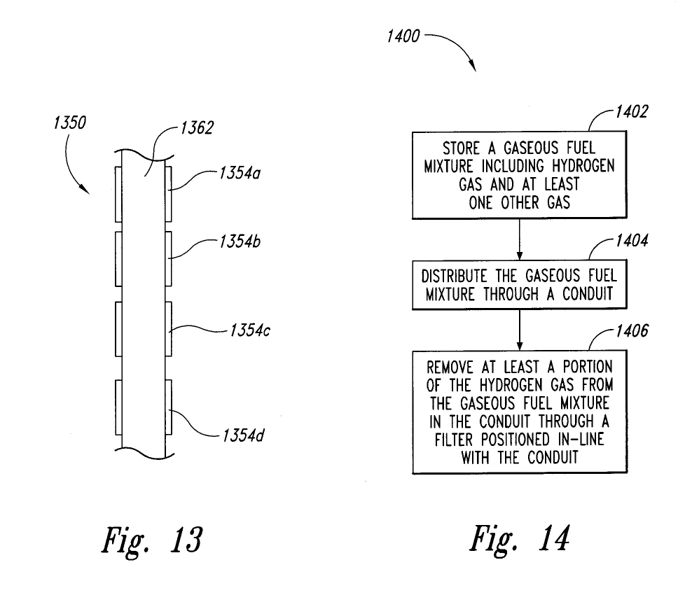

FIG. 13 is a schematic diagram of a selective outcome filter assembly 1350 configured in accordance with another embodiment of the disclosure. In the illustrated embodiment, the filter assembly 1350 includes multiple electrolyzers or filters 1354 (shown schematically and identified individually as first through further filters 1354a-1354d) positioned inline with a conduit 1362. In certain embodiments, the conduit 1362 can be a natural gas conduit, such as natural gas conduit in a pre-existing network of natural gas conduits. Moreover, the filters 1354 can be configured to remove hydrogen that has been added to the natural gas in the conduit 1362 for different purposes or end results. For example, each of the filters 1354 can include any of the features described above with reference to the filter 254 of FIGS. 11 and 12, including, for example, corresponding electrolyzer electrodes. Furthermore, although four filters 1354 are shown in FIG. 13, the separation of these filters 1354 as individual spaced-apart filters is for purposes of illustration. For example, although the filters 1354 may provide different outcomes or functions as described in detail below, in other embodiments the filters 1354 can be combined into a single filter assembly.

As noted above, the filters 1354 are schematically illustrated as separate filters for selectively filtering hydrogen for one or more purposes. In one embodiment, for example, the first filter 1354a can be a hydrogen filter that removes hydrogen from a gaseous fuel mixture in the conduit 1362 including hydrogen and at least one other gas, such as natural gas. The first filter 1354a can accordingly remove a portion of the hydrogen (e.g., by ion exchange and/or sorption including adsorption and absorption) from the fuel mixture for the purpose of providing the hydrogen as a fuel to one or more fuel consuming devices. The second filter 1354b can be configured to produce electricity when removing the hydrogen from the gaseous fuel mixture. For example, as the hydrogen ions pass through the second filter 1354b, electrons pass to the electron deficient side of the second filter 1354b (e.g., a side of the second filter 1354b exposed to Oxygen or other oxidant and opposite the side of the gaseous fuel mixture). The third filter 1354c can be used to provide water as an outcome of filtering the hydrogen from the gaseous fuel mixture. Moreover, the fourth filter 1354d can be used to filter hydrogen from the gaseous fuel mixture and to combine the filtered hydrogen with one or more other stored fuels to create an enriched or Hyboost fuel source. For example, the filtered hydrogen can be added to a reservoir of existing gas fuels.

As noted above, although the filters 1354 of the illustrated embodiment are shown as separate filters, in other embodiments any of the functions of the first through fourth filters 1354a-1354d (e.g., providing hydrogen, providing electricity, providing water, and/or providing an enriched fuel source) can be accomplished by a single filter assembly 1354. The illustrated embodiment according provides for the storage and transport of hydrogen mixed with at least natural gas using existing natural gas lines and networks. The filters 1354 as described herein accordingly provide for filtering or otherwise removing at least a portion of the hydrogen for specific purposes.

FIG. 14 is a process flow diagram of a method or process 1400 configured in accordance with an embodiment of the disclosure. In the illustrated embodiment, the process 1400 includes storing a gaseous fuel mixture including hydrogen and at least one other gas (block 1402). In one embodiment, for example, the hydrogen can make up approximately 20% or less of the gaseous fuel mixture. In other embodiments, however, the natural gas can be greater than or less than approximately 20% of the gaseous fuel mixture. The process 1400 further includes distributing the gaseous fuel mixture through a conduit (block 1404). In certain embodiments, the conduit can be a natural gas conduit, such as a conventional or pre-existing natural gas conduit as used to distribute natural gas for residential, commercial, and/or other purposes. In other embodiments, however, the conduit can be other types of conduit suitable for distributing the gaseous fuel mixture.

The process 1400 further includes removing at least a portion of the hydrogen from the gaseous fuel mixture (block 1406). Removing at least a portion of the hydrogen can include removing the hydrogen from the conduit through a filter positioned in-line with the conduit. For example, the filter can be a filter generally similar in structure and function to any of the filters described above with reference to FIGS. 11-13. The process of removing the hydrogen can be used to provide the hydrogen as a fuel to a fuel consuming device, produce electricity, produce water, and or produce hydrogen for combination with one or more other fuels to produce an enriched fuel mixture.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure.

I claim:

1. An energy conversion system comprising:
a housing at least partially defining a cavity;
a generator assembly including—
a first generator subassembly positioned within the cavity, wherein the first generator subassembly includes multiple first conductors that remain generally stationary with reference to the housing;
a second generator subassembly movably positioned within the cavity proximate to the first generator subassembly, wherein the second generator subassembly includes multiple second conductors positioned adjacent to the first conductors;
a motion driver operably coupled to the generator assembly, wherein the motion driver reciprocally moves relative to the housing to move the second conductors relative to the first conductors to produce an electrical current;
an electrolysis assembly positioned within the housing and fluidly coupled to the cavity, wherein a portion of the current produced by the first and second generator assemblies drives the electrolysis assembly to produce a gas to at least partially pressurize the cavity with the gas; and
an output coupled to the housing and configured to allow at least a portion of the current to be accessible from the system.

2. The system of claim 1 wherein the generator assembly is a linear generator assembly and wherein the motion driver moves the second conductors in first and second directions that are generally parallel with a longitudinal axis of the housing.

3. The system of claim 1 wherein the generator assembly is a rotary generator assembly and wherein the motion driver moves the second conductors in a generally circular direction proximate to the first conductors.

4. The system of claim 1 wherein the energy conversion system is a hydroelectric energy conversion system configured to be positioned in water, and wherein the motion driver moves in response to movement of the water.

5. The system of claim 4 wherein movement of the water comprises at least one of waves in the water, current flow in the water, and tidal movement of the water.

6. The system of claim 4 wherein the motion driver is a flotation unit spaced apart from the housing and configured to be positioned proximate to a surface of the water, and wherein the system further comprises a cable that couples the floatation unit to the generator assembly.

7. The system of claim 4 wherein the motion driver is a propeller spaced apart from the housing and configured to be submerged in the water, and wherein the system further includes a drive shaft that couples the propeller to the generator assembly.

8. The system of claim 1, further comprising a controller operatively coupled to the electrolysis assembly and configured to adaptively control the pressure in the cavity to affect at least one of reducing friction between the first generator subassembly and the second generator subassembly, controlling a position of the first generator subassembly relative to the second generator subassembly, or reducing growth of marine organisms within the cavity.

9. The system of claim 1 wherein the gas is hydrogen.

10. The system of claim 9 wherein the hydrogen is a first gas and wherein the electrolysis assembly is configured to produce a second gas, the electrolysis assembly further comprising a first electrode spaced apart from a second electrode and a semi-permeable membrane configured to separate the hydrogen from the second gas.

11. The system of claim 1, further comprising:
an electrical line operably coupled to the output; and
an electricity distribution grid operably coupled to the electrical line, wherein the electrical line is configured to deliver the current to the electricity distribution grid and the electricity distribution grid is configured to further provide electricity to one or more customers.

12. The system of claim 1, further comprising one or more internal combustion engines operably coupled to the motion driver.

13. The system of claim 1 wherein at least one of the first conductor and the second conductors does not include a copper material.

14. A hydroelectric energy conversion apparatus comprising:
a housing;
a first generator assembly positioned within the cavity, wherein the first generator assembly includes a first tubular dielectric body carrying multiple spaced apart first conductors, and wherein the first generator assembly at least partially defines a cavity;
a second generator assembly positioned proximate to the first generator assembly within the cavity, wherein the second generator assembly includes a second tubular dielectric body concentrically positioned relative to the first tubular dielectric body, wherein the second tubular dielectric body carries multiple spaced apart second conductors proximate to the corresponding first conductors, and wherein the second tubular body is movable within the first tubular body along a longitudinal axis of the first body;
a flotation device spaced apart from the housing and operably coupled to the second tubular dielectric body, wherein the floatation device is configured to move in response to movement of the water to move the second conductors relative to the first conductors to produce an electrical current; and
an electrolyzer positioned within the housing and fluidly coupled to the cavity, wherein a portion of the current drives the electrolyzer to produce a gas that at least partially pressurizes the cavity.

15. The apparatus of claim 14 wherein the first conductors comprise a plurality of electrically coupled metallic rings extending circumferentially around the first tubular dielectric body.

16. The apparatus of claim 15 wherein the metallic rings include a first group of electrically interconnected metallic rings and a second group of electrically interconnected metallic rings.

17. The apparatus of claim 16 wherein the second tubular dielectric body moves the second conductors between a first position and a second position, wherein in the first position the second conductors are positioned adjacent to corresponding first metallic rings of the first group and in the second position the second conductors are positioned adjacent to corresponding second metallic rings of the second group.

18. The apparatus of claim 14 wherein the second conductors comprise a plurality of metallic rings extending circumferentially around the first tubular dielectric body.

19. The apparatus of claim 14 wherein a frequency of the electrical current is a function of a frequency of a wave movement of the water multiplied by the number of second conductors.

20. The apparatus of claim 14 wherein the first tubular dielectric body includes a plurality of grooves extending circumferentially around and at least partially recessed therein, wherein individual grooves receive corresponding second conductors.

21. The apparatus of claim 14, further comprising:
a retractor carried by the housing;
a cable having a first end portion opposite a second end portion, wherein the first end portion is operably coupled to the retractor; and
a base portion configured to be anchored to a seafloor and operably coupled to the second end portion of the cable, wherein the retractor is configured to perform at least one of retracting or extending the cable to adjust a height of the housing relative to the seafloor.

22. The apparatus of claim 14, further comprising:
a first end cap of the second generator assembly opposite a second end cap of the second generator assembly;
a first biasing member positioned in the cavity adjacent to the first end cap; and
a second biasing member positioned in the cavity adjacent to the second end cap in the first end portion and a second biasing member positioned in the second end portion, and wherein the first and second biasing members contact the corresponding first and second end caps to adjust a position of the second generator assembly within the cavity.

23. The apparatus of claim 22 wherein the first end cap is positioned between the second end cap and the floatation device, and wherein the second end cap is heavier than the first end cap.

24. The apparatus of claim 14 wherein the first and second tubular dielectric bodies are made of at least one of the following materials: polyethylene, polypropylene, or polymethylbutene.

25. The apparatus of claim 14 wherein the gas comprises hydrogen in addition to one or more other gases, and wherein the electrolyzer further includes filter to separate the hydrogen from the one or more other gases.

26. The apparatus of claim 14 wherein the electrolyzer further comprises a first electrode operably spaced apart from a second electrode in a fluid, and wherein the portion of the current that drives the electrolyzer is configured to liberate hydrogen from the fluid without liberating oxygen or chlorine from the fluid.

27. The apparatus of claim 14 wherein:
the first generator assembly includes multiple first magnets positioned between the corresponding first conductors; and
the second generator assembly includes multiple second magnets positioned between the corresponding second conductors and positioned proximate to the corresponding first magnets.

28. A hydroelectric energy conversion apparatus comprising:
a housing at least partially defining an interior cavity;
a first generator assembly positioned within the cavity, wherein the first generator assembly includes a first cylindrical dielectric body carrying multiple spaced apart first conductors;
a second generator assembly positioned proximate to the first generator assembly within the cavity, wherein the second generator assembly includes a second cylindrical dielectric body concentrically disposed within at least a portion of the first cylindrical dielectric body, wherein the second cylindrical dielectric body carries multiple spaced apart second conductors
a driveshaft operably coupled to the second cylindrical dielectric body;
a propeller operably coupled to the driveshaft, wherein the propeller is configured to move in response to movement of the water to rotate the driveshaft and the corresponding second conductors relative to the first conductors to produce an electric current; and
an electrolyzer positioned within the housing and fluidly coupled to the cavity, wherein a portion of the current drives the electrolyzer to produce a gas that at least partially pressurizes the cavity.

29. The apparatus of claim 28 wherein the second dielectric body rotates the second conductors along a generally circular path adjacent to the first conductors.

30. The apparatus of claim 28 wherein the first conductors include a first group of electrically interconnected metallic strips and a second group of interconnected metallic strips.

31. The apparatus of claim 28 wherein the second conductors include metallic strips that are carried by at an outer peripheral location on the second cylindrical dielectric body.

32. The apparatus of claim 28 wherein:
the first cylindrical dielectric body is a first stationary cylindrical dielectric body and wherein the first generator assembly further comprises—
third stationary cylindrical dielectric body carrying third conductors and spaced radially outwardly from the first dielectric cylindrical body; and
a fifth stationary cylindrical dielectric body carrying fifth conductors and spaced radially outwardly from the third dielectric cylindrical body; and
the second cylindrical dielectric body is a second movable cylindrical dielectric body and wherein the second generator assembly further comprises—
a fourth movable cylindrical dielectric body carrying fourth conductors and positioned between the first and third stationary dielectric cylindrical bodies; and
a sixth movable cylindrical dielectric body carrying sixth conductors and positioned between the third and fifth stationary dielectric cylindrical bodies.

33. The apparatus of claim 28 wherein the housing includes a first end portion opposite a second end portion, and wherein the second, fourth, and sixth movably cylindrical dielectric bodies extend from the first end portion towards the second end portion, and wherein the first, third, and fifth movable cylindrical dielectric bodies extend from the second end portion towards the first end portion.

34. The system of claim 28, further comprising a controller operatively coupled to the electrolyzer and configured to adaptively control the pressure in the cavity to affect at least one of reducing friction between the first generator assembly and the second generator assembly, controlling a position of the first generator assembly relative to the second generator assembly, or reducing growth of marine organisms within the cavity.

35. A distribution assembly comprising:
a fuel source including a gaseous fuel mixture of hydrogen gas and at least one other gas;
a fuel conduit coupled to the fuel source and configured to transport the gaseous fuel mixture; and
a filter subassembly operably coupled to the fuel conduit, wherein the filter subassembly includes a membrane having a first side in fluid communication with the gaseous fuel mixture and a second side opposite the first side, and wherein the filter subassembly is configured to remove at least a portion of the hydrogen gas from the gaseous fuel mixture as the hydrogen gas passes through the membrane from the first side to the second side.

36. The assembly of claim 35 wherein the filter subassembly is configured to further perform at least one of the following—
provide the hydrogen gas as a fuel after the hydrogen gas exits the second side of the selective membrane;
produce electricity as the hydrogen gas passes through the selective membrane from the first side to the second side;
produce water as the hydrogen passes through the selective membrane from the first side to the second side; and
provide a combined fuel mixture of the hydrogen gas that passes through the membrane in addition to at least one other gas that passes through the membrane.

37. The assembly of claim 35 wherein the membrane is concentrically positioned in-line with the conduit.

38. The assembly of claim 35 wherein the membrane is configured to remove at least a portion of the hydrogen gas by at least one of the following: an ionization process, an adsorption process, and an absorption process.

39. The assembly of claim 35 wherein the filter subassembly includes a first electrode adjacent to the first side of the membrane and a second electrode adjacent to the second side of the electrode.

40. The assembly of claim 35 wherein the fuel conduit is a natural gas conduit.

41. The assembly of claim 35 wherein the gaseous fuel mixture includes at least hydrogen gas and natural gas.

42. The assembly of claim 41 wherein the natural gas comprises approximately 20% or less of the gaseous fuel mixture.

43. A method of distributing a gaseous fuel mixture, the method comprising:
storing a gaseous fuel mixture of hydrogen gas and at least one other gas;
distributing the gaseous fuel mixture through a conduit; and
removing at least a portion of the hydrogen gas from the gaseous fuel mixture in the conduit through a filter positioned in-line with the conduit.

44. The method of claim 43 wherein distributing the gaseous fuel mixture comprises distributing the gaseous fuel mixture through a pre-existing natural gas conduit.

45. The method of claim 43, further comprising providing the hydrogen that was removed through the filter as a hydrogen fuel.

46. The method of claim 43 wherein removing at least a portion of the hydrogen gas comprises passing at least a portion of the hydrogen gas through the filter, and wherein the method further comprises producing electricity by passing the hydrogen gas through the filter.

47. The method of claim 43 wherein removing at least a portion of the hydrogen gas comprises passing at least a portion of the hydrogen gas through the filter, and wherein the method further comprises producing water with the hydrogen gas that passes through the filter.

48. The method of claim 43, further comprising:
removing at least one other gas from the fuel mixture through the filter combining the removed hydrogen gas with the removed at least one other gas.

49. The method of claim 43, further comprising applying a voltage differential between a first electrode positioned adjacent to a first side of the filter and a second electrode positioned adjacent to a second side of the filter opposite the first side.

50. The method of claim 43 wherein storing the gaseous fuel mixture of hydrogen gas and at least one other gas comprises adding the hydrogen gas to at least natural gas.

51. The method of claim 43 wherein storing the gaseous fuel mixture with at least 20% of the gaseous fuel mixture being hydrogen gas.

52. The method of claim 43 wherein removing at least a portion of the hydrogen gas comprises at least one of the following: ionizing at least a portion of the hydrogen gas, adsorping at least a portion of the hydrogen gas through the filter, and adsorbing at least a portion of the hydrogen gas through the filter.
